(19) United States
(12) Patent Application Publication
(10) Pub. No.: US 2026/0093567 A1
(43) Pub. Date: Apr. 2, 2026

(54) COMMON DATA RETRIEVAL FRAMEWORK

(71) Applicant: AT&T Intellectual Property I, L.P., Atlanta, GA (US)

(72) Inventors: Subrat Kumar Patra, Schaumburg, IL (US); Ashish Palse, Cumming, GA (US); Abdulla Udaipurwala, Monroe Township, NJ (US)

(73) Assignee: AT&T Intellectual Property I, L.P., Atlanta, GA (US)

(21) Appl. No.: 18/903,491

(22) Filed: Oct. 1, 2024

(51) Int. Cl. G06F 9/54

(52) U.S. Cl. CPC G06F 9/547

(57) ABSTRACT

Aspects of the subject disclosure may include, for example, storing first configuration information corresponding to a first API that facilitates communication with a first software service, and storing second configuration information corresponding to a second API that facilitates communication with a second software service; receiving a first client request associated with a first software program; and responsive to receiving the first client request, transmitting a first communication, wherein: in a first case that the first client request identified the first software service as a selected software service, the first communication comprises first information that is sent to the first software service via the first API; and in a second case that the first client request identified the second software service as the selected software service, the first communication comprises second information that is sent to the second software service via the second API. Other embodiments are disclosed.

### FIELD OF THE DISCLOSURE

The subject disclosure relates to a common data retrieval framework.

### BACKGROUND

Creating seamless connectivity between applications, and providing incremental data feed capability in an ever-increasing load of network of applications with a myriad of different interfaces and data points, is a major challenge to any large corporation.

For example, when an application needs to send an information query to another system (e.g., a generative AI system, AZURE, DEEP, or any on-premise system) the application typically must have previously gone through a process via which an application interface design document (AID) and its associated interface/code is created (sometimes from scratch) and maintained. This process often creates a delay in delivery as well as maintenance problems. Also, reusability often suffers when the communications are across systems (e.g., an API from system 1 cannot typically be used in system 2 unless there is a new AID and new interface/code created).

### BRIEF DESCRIPTION OF THE DRAWINGS

Reference will now be made to the accompanying drawings, which are not necessarily drawn to scale, and wherein:

FIG. 1A is a block diagram illustrating an example, non-limiting embodiment of a system in accordance with various aspects described herein.

FIG. 1B is a block diagram illustrating an example, non-limiting embodiment of a system in accordance with various aspects described herein.

FIG. 1C is a block diagram illustrating an example, non-limiting embodiment of a process flow in accordance with various aspects described herein.

FIG. 2A depicts an illustrative embodiment of a method in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for a common data retrieval framework (sometimes referred to herein as CDRF). Other embodiments are described in the subject disclosure.

One or more aspects of the subject disclosure include a platform/framework that eliminates (or reduces) the need to repetitively re-create certain software interfaces. Such a platform/framework can be implemented in hardware, firmware, software, or a combination thereof. Such a platform/framework can provide a no code (or low code) capability to avoid a new deployment every time new information needs to be queried.

One or more aspects of the subject disclosure include a device comprising: a processing system including a processor; and a memory that stores executable instructions that, when executed by the processing system, facilitate performance of operations, the operations comprising: storing configuration information associated with a plurality of application programming interfaces (APIs), wherein the configuration information comprises first configuration information corresponding to a first API that facilitates communication with a first software service, and wherein the configuration information comprises second configuration information corresponding to a second API that facilitates communication with a second software service, wherein the second API is distinct from the first API, and wherein the second software service is distinct from the first software service; receiving a first client request associated with a first software program, wherein the first client request identifies one of the first software service and the second software service as a selected software service; and responsive to receiving the first client request, transmitting a first communication, wherein: in a first case that the first client request identified the first software service as the selected software service, the first communication comprises first information that is sent to the first software service via the first API; and in a second case that the first client request identified the second software service as the selected software service, the first communication comprises second information that is sent to the second software service via the second API.

One or more aspects of the subject disclosure include a non-transitory machine-readable medium comprising executable instructions that, when executed by a processing system including a processor, facilitate performance of operations, the operations comprising: storing in a database a plurality of tasks, wherein the plurality of tasks comprise a first task and a second task, and wherein the first task is a different task than the second task; storing in the database a plurality of application programming interface (API) calls, wherein the plurality of API calls comprise a first API call that is associated with the first task and a second API call that is associated with the second task, wherein the first API call is a different API call than the second API call, wherein the first API call facilitates communication with a first software service, wherein the second API call facilitates communication with a second software service, and wherein the first software service is a different software service than the second software service; receiving a first client request associated with a first software program, wherein the first client request identifies the first task; responsive to receiving the first client request, retrieving from the database the first API call that is associated with the first task; responsive to receiving the first client request, transmitting a first communication to the first software service, wherein the first communication is made via the first API call that is retrieved; responsive to the first communication being made, receiving a first responsive communication from the first software service, wherein the first responsive communication that is received comprises first data, first instructions to perform a first operation, or any first combination thereof; and forwarding, to the first software program, the first data, the first instructions to perform the first operation, or the first combination thereof.

One or more aspects of the subject disclosure include a method comprising: obtaining, by a processing system including a processor, a first application programming interface (API) call that facilitates communication with a first software service; obtaining, by the processing system, a first task that can be requested for execution; storing, by the processing system, the first task and the first API call in a database, wherein the first task and the first API call are associated with one another in the database; obtaining, by the processing system, a second API call that facilitates communication with a second software service; obtaining, by the processing system, a second task that can be requested for execution; storing, by the processing system, the second task and the second API call in the database, wherein the second task and the second API call are associated with one another in the database; receiving, by the processing system, a first request associated with a first software application, wherein the first request is for execution of the first task; responsive to the receiving the first request, obtaining by the processing system, from the database, the first API call that is associated with the first task; responsive to the obtaining the first API call from the database, transmitting by the processing system, a first communication to the first software service via the first API call; receiving, by the processing system, a second request associated with a second software application, wherein the second request is for execution of the second task; responsive to the receiving the second request, obtaining by the processing system, from the database, the second API call that is associated with the second task; and responsive to the obtaining the second API call from the database, transmitting by the processing system, a second communication to the second software service via the second API call.

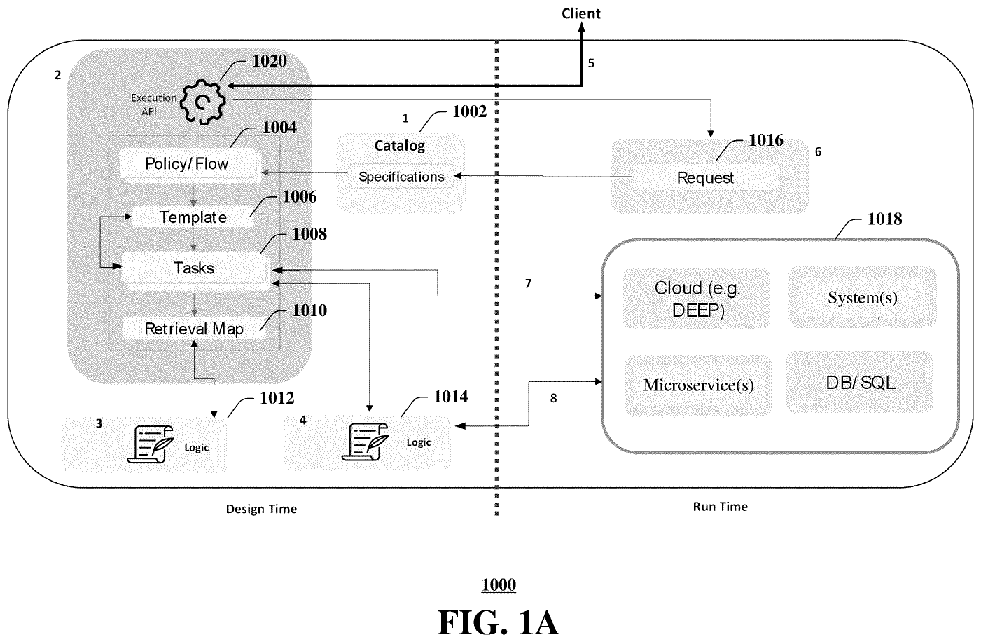

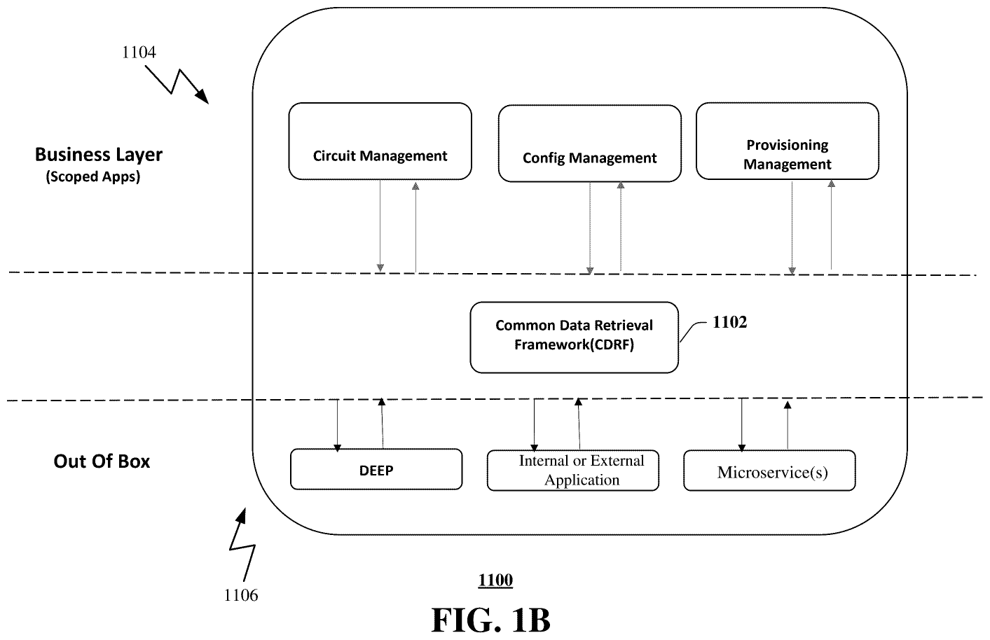

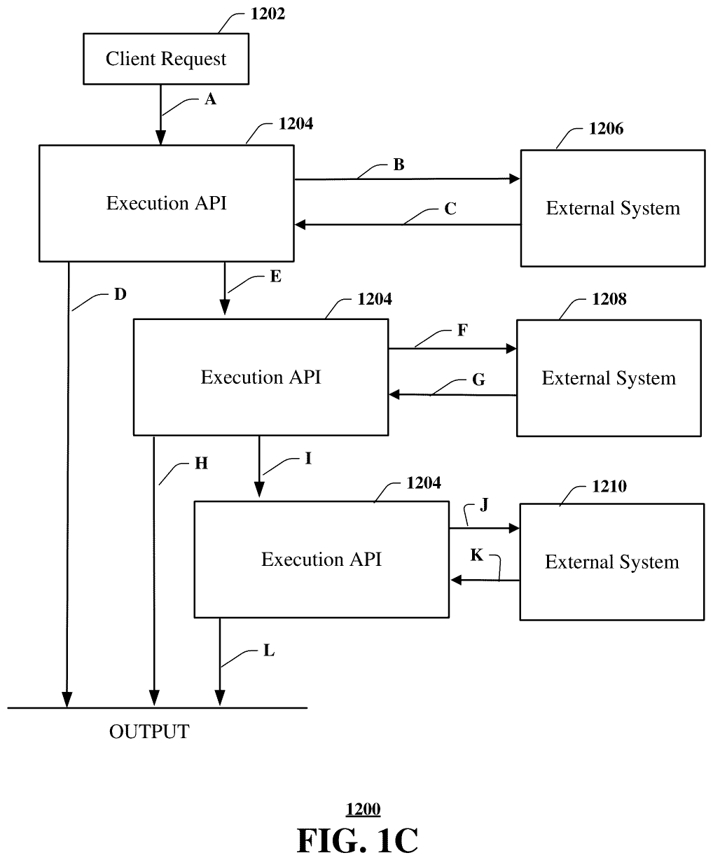

Referring now to FIG. 1A, this is a block diagram illustrating an example, non-limiting embodiment of a system 1000 in accordance with various aspects described herein. As seen in this figure, certain design time aspects related to Catalog 1002 (defining specifications and necessary elements), Execution API 1020 (which resolves a particular attribute from the specification), Logic 1012 (which can determine, for example, a subset of data to pass on to a subsequent task), and Logic 1014 (which can communicate data during run time) are implemented. In operation, after design time, a run time client can make a call (see arrow 5) to the Execution API 1020, which in turn makes a Request 1016 to Catalog 1002 (after which the policy/templates/tasks are used by the Execution API 1020 to query (and receive data from) applications/services 1018). These applications/services 1018 can include, for example: cloud-based applications/services; closed (or internal) systems-based applications/services; microservices; and/or database services (e.g., queries).

Reference will now be made to certain design time artifacts according to various embodiments. Such design time artifacts can include industry standard artifacts and business orchestration. The industry standard artifacts can include a product catalog (see, e.g., 1002 of FIG. 1A). Such a product catalog can include: (a) Specifications Interface designs for exposing capabilities; and (b) Characteristics—Expected inputs and outputs. The Business orchestration can include the following: (a) Policy—Represents use case; (b) Template-Represents collections of steps/activities needed to fulfill the given request; (c) Task—abstract exposing a logic that can be plugged into any template; (d) Logic—business logic; and (e) Execution API—Framework that orchestrates the set of tasks corresponding to given request.

Reference will now be made to certain run time artifacts according to various embodiments. Such run time artifacts can include a data model (which itself can include industry standard artifacts as well as an Execution API (see, e.g., 1020 of FIG. 1A). The industry standard artifacts can include: (a) Request (see, e.g., 1016 of FIG. 1A) Customer request (e.g. site id, order id etc.); this can also include the attributes needed to fulfill the given request depending upon use case and industry; (b) Task (see, e.g., 1008 of FIG. 1A)—Set of activities needed to be accomplished to fulfill the requested sub-request; these tasks can have various types of relationships with other tasks as well (such as inter-dependency, parent-child nested tasks etc.). The Execution API (see, e.g., 1020 of FIG. 1A) can operate in the following nested manner: (a) Picks up respective policy (see, e.g., 1004 of FIG. 1A) based on given request; (b) Picks up template (see, e.g., 1006 of FIG. 1A) corresponding to given policy; (c) Executes the tasks defined in the template; (d) Executes logic corresponding to the given task definition mapped in template task; (e) Retrieves the requested value(s); (f) Builds the response back to the client.

Referring now to FIG. 1B, this is a block diagram illustrating an example, non-limiting embodiment of a system 1100 in accordance with various aspects described herein. As seen in this figure, CDRF 1102 acts as an intermediary between various scoped applications in a Business Layer 1104 and various applications/software services in an “Out of Box” or (external) area 1106. In various examples, the scoped applications in the Business Layer 1104 can comprise any desired internal and/or external application(s) and the applications/software services in the Out of Box area 1106 can comprise any: cloud-based applications/services; closed (or internal) systems-based applications/services; microservices; and/or database services (e.g., queries). In operation, the CDRF 1102 can act as both a repository as well as an executor (wherein, for example, the CDRF 1102 can call the relevant applications/services to retrieve desired data and provide the output to the clients).

Referring now to FIG. 1C, this is a block diagram illustrating an example, non-limiting embodiment of a process flow 1200 in accordance with various aspects described herein. As seen in this figure, a Client Request 1202 is input (see arrow “A”) to Execution API 1204. In various examples, the Execution API 1204 can comprise hardware, firmware, software, or a combination thereof. The Execution API 1204 can operate to provide functionality as described herein (e.g., using templates, tasks, and the like) to request data from External System 1206 (see arrow “B”) and to in response receive data from External System 1206 (see arrow “C”). Some or all of the data that is returned can be output (see arrow “D”) and some or all of the data that is returned can be fed back (see arrow “E”) to the Execution API 1204 for further processing (e.g., iterative processing). In this regard, the Execution API 1204 can again operate to provide functionality as described herein (e.g., using templates, tasks, and the like) to request data from External System 1208 (see arrow “F”) and to in response receive data from External System 1208 (see arrow “G”). Some or all of the data that is returned can be output (see arrow “H”) and some or all of the data that is returned can be fed back (see arrow “I”) to the Execution API 1204 for further processing (e.g., iterative processing). Further, the Execution API 1204 can again operate to provide functionality as described herein (e.g., using templates, tasks, and the like) to request data from External System 1210 (see arrow “J”) and to in response receive data from External System 1210 (see arrow “K”). Some or all of the data that is returned can be output (see arrow “L”). Of course, such iteration can be performed as many times as desired. Of note, while (in this example) each of External Systems 1206, 1208, 1210 is distinct from one another, in other examples, one or more of External Systems 1206, 1208, 1210 can be the same system.

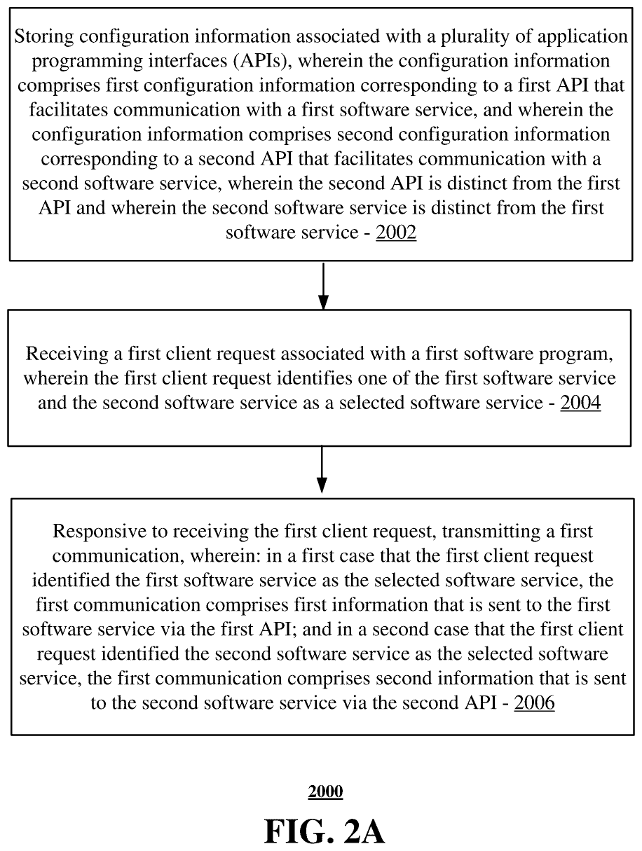

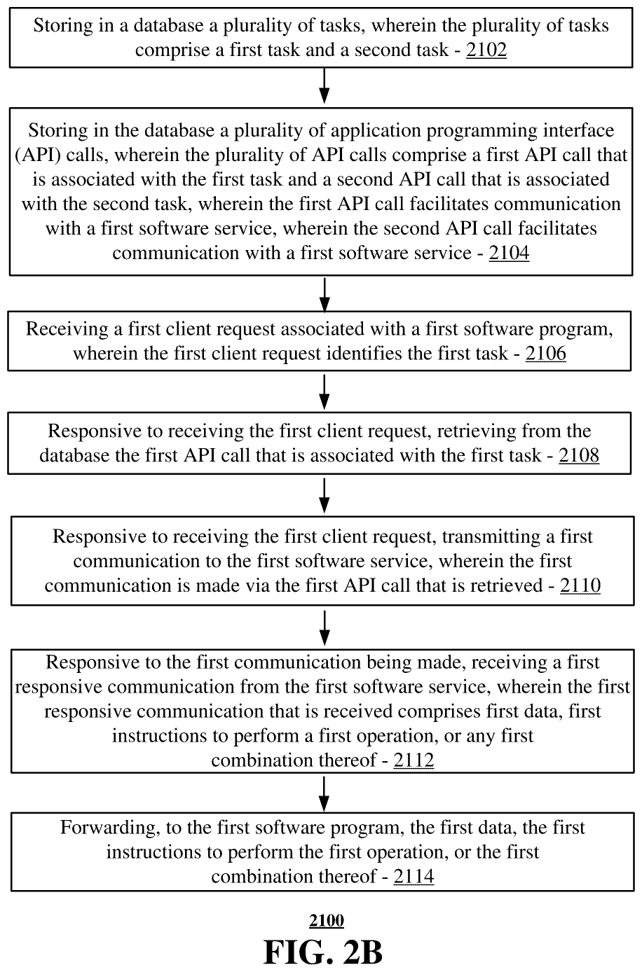

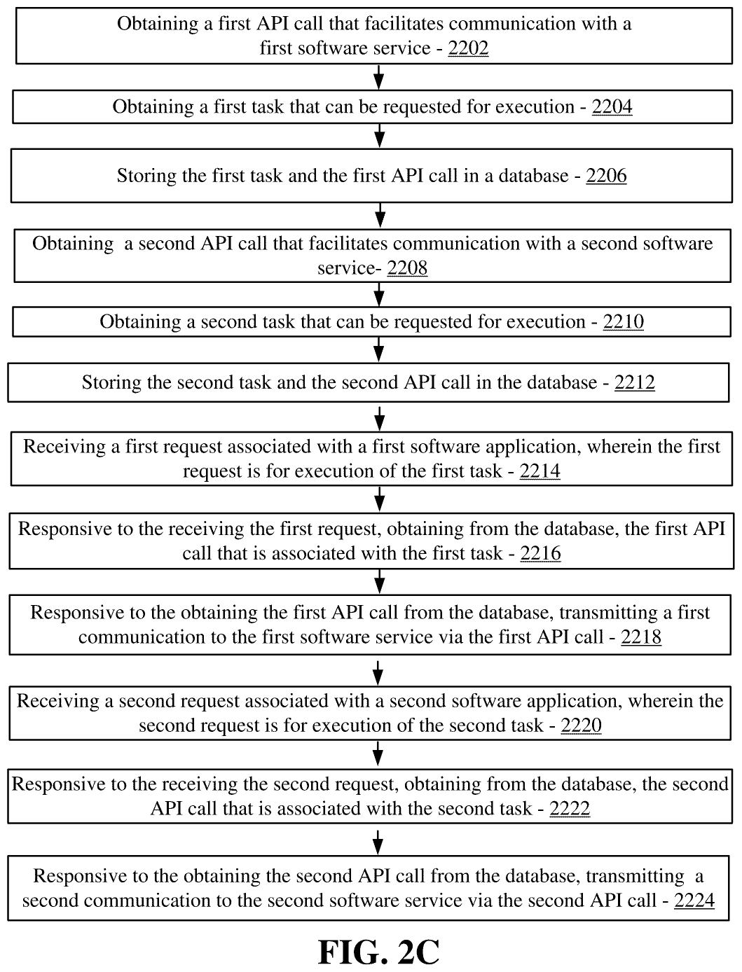

Referring now to FIG. 2A, various steps of a method 2000 according to an embodiment are shown. As seen in this FIG. 2A, step 2002 comprises storing configuration information associated with a plurality of application programming interfaces (APIs), wherein the configuration information comprises first configuration information corresponding to a first API that facilitates communication with a first software service, and wherein the configuration information comprises second configuration information corresponding to a second API that facilitates communication with a second software service, wherein the second API is distinct from the first API, and wherein the second software service is distinct from the first software service. Next, step 2004 comprises receiving a first client request associated with a first software program, wherein the first client request identifies one of the first software service and the second software service as a selected software service. Next, step 2006 comprises responsive to receiving the first client request, transmitting a first communication, wherein: in a first case that the first client request identified the first software service as the selected software service, the first communication comprises first information that is sent to the first software service via the first API; and in a second case that the first client request identified the second software service as the selected software service, the first communication comprises second information that is sent to the second software service via the second API.

While for purposes of simplicity of explanation, the respective processes are shown and described as a series of blocks in FIG. 2A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2B, various steps of a method 2100 according to an embodiment are shown. As seen in this FIG. 2B, step 2102 comprises storing in a database a plurality of tasks, wherein the plurality of tasks comprise a first task and a second task, and wherein the first task is a different task than the second task. Next, step 2104 comprises storing in the database a plurality of application programming interface (API) calls, wherein the plurality of API calls comprise a first API call that is associated with the first task and a second API call that is associated with the second task, wherein the first API call is a different API call than the second API call, wherein the first API call facilitates communication with a first software service, wherein the second API call facilitates communication with a second software service, and wherein the first software service is a different software service than the second software service. Next, step 2106 comprises receiving a first client request associated with a first software program, wherein the first client request identifies the first task. Next, step 2108 comprises responsive to receiving the first client request, retrieving from the database the first API call that is associated with the first task. Next, step 2110 comprises responsive to receiving the first client request, transmitting a first communication to the first software service, wherein the first communication is made via the first API call that is retrieved. Next, step 2112 comprises responsive to the first communication being made, receiving a first responsive communication from the first software service, wherein the first responsive communication that is received comprises first data, first instructions to perform a first operation, or any first combination thereof. Next, step 2114 comprises forwarding, to the first software program, the first data, the first instructions to perform the first operation, or the first combination thereof.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2C, various steps of a method 2200 according to an embodiment are shown. As seen in this FIG. 2C, step 2202 comprises obtaining, by a processing system including a processor, a first application programming interface (API) call that facilitates communication with a first software service. Next, step 2204 comprises obtaining, by the processing system, a first task that can be requested for execution. Next, step 2206 comprises storing, by the processing system, the first task and the first API call in a database, wherein the first task and the first API call are associated with one another in the database. Next, step 2208 comprises obtaining, by the processing system, a second API call that facilitates communication with a second software service. Next, step 2210 comprises obtaining, by the processing system, a second task that can be requested for execution. Next, step 2212 comprises storing, by the processing system, the second task and the second API call in the database, wherein the second task and the second API call are associated with one another in the database. Next, step 2214 comprises receiving, by the processing system, a first request associated with a first software application, wherein the first request is for execution of the first task. Next, step 2216 comprises responsive to the receiving the first request, obtaining by the processing system, from the database, the first API call that is associated with the first task. Next, step 2218 comprises responsive to the obtaining the first API call from the database, transmitting by the processing system, a first communication to the first software service via the first API call. Next, step 2220 comprises receiving, by the processing system, a second request associated with a second software application, wherein the second request is for execution of the second task. Next, step 2222 comprises responsive to the receiving the second request, obtaining by the processing system, from the database, the second API call that is associated with the second task. Next, step 2224 comprises responsive to the obtaining the second API call from the database, transmitting by the processing system, a second communication to the second software service via the second API call.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments provide a platform/framework that distinguishes between design time and run time (wherein, for instance, a design time interface can be created without deployment and then subsequently used at run time).

As described herein, various embodiments provide a platform/framework that facilitates obtaining from one or more web applications desired information.

As described herein, various embodiments provide a platform/framework that facilitates use of an AI interface that is trained to obtain data (e.g., based on the data that is entered in the platform/framework).

As described herein, various embodiments provide for one or more templates that support a plurality of APIs for communication between various software applications/services. In various examples, an API can be a SOAP API, a RESTful API, or any combination thereof. In various examples, a software application/service can be accessed via (and/or can return information via) a function and/or a script. In various examples, a function and/or a script can relate to a VLAN, to a data setting, to a data request, to a data post, to a data conversion, to a data validation, to a string conversion, or to any combination thereof.

As described herein, various embodiments provide a self-service model that enables a program to focus on business logic from day one. Such a self-service model can: (a) be configurable and low-code (or no-code); (b) provide manageability (e.g., easy to change/update); and/or (c) provide a complete end-to-end view of the data retrieval.

As described herein, various embodiments provide for reusability. Such reusability can include write-once and reuse as follows: (a) adding and/or managing data elements; (b) daisy chaining CDRF templates; and/or (c) trainable by generative AI.

As described herein, various embodiments provide for simplified design time experience and enhanced run time experience (e.g., no code/low code).

As described herein, various embodiments provide for extendibility. For example, various embodiments can be extended to: Generative AI (e.g., train the LLM to perform action based on prompts to perform a particular template); DEEP (Palantir); Service Now; any cloud SaaS infrastructure where you can write applications; Snowflake; and/or any desired on-premise application as needed.

As described herein, various embodiments provide for a low learning curve.

As described herein, various embodiments provide for: (a) increasing reusability; (b) minimizing delay in implementation; (c) reducing maintenance issues; (d) eliminating a need for code build and deployment every time a change is made; (e) reducing (or eliminating) cost of maintaining multiple interfaces; (f) increasing end-to-end visibility; and/or (g) trainable by Gen-AI.

As described herein, various embodiments provide a streamlined process via which a single interface can be implemented in a no code (or low code) manner, and in which run time and design time are distinguished to increase flexibility. In one specific example, JSON can be used to facilitate communications between software elements.

As described herein, various embodiments provide a mechanism to communicate via APIs to generative AI (for instance, to communicate generative AI queries so that retrieving data in a complex network of applications and systems is facilitated).

As described herein, various embodiments provide for a common data retrieval framework that can be implemented in hardware, firmware, software, or any combination thereof.

As described herein, various embodiments can operate in the context of network systems, in the context of any large systems that utilize many interfaces and that require deep searching of data, or to any combination thereof.

As described herein, various embodiments can help to reduce cost, reduce maintenance, increase efficiency, or any combination thereof.

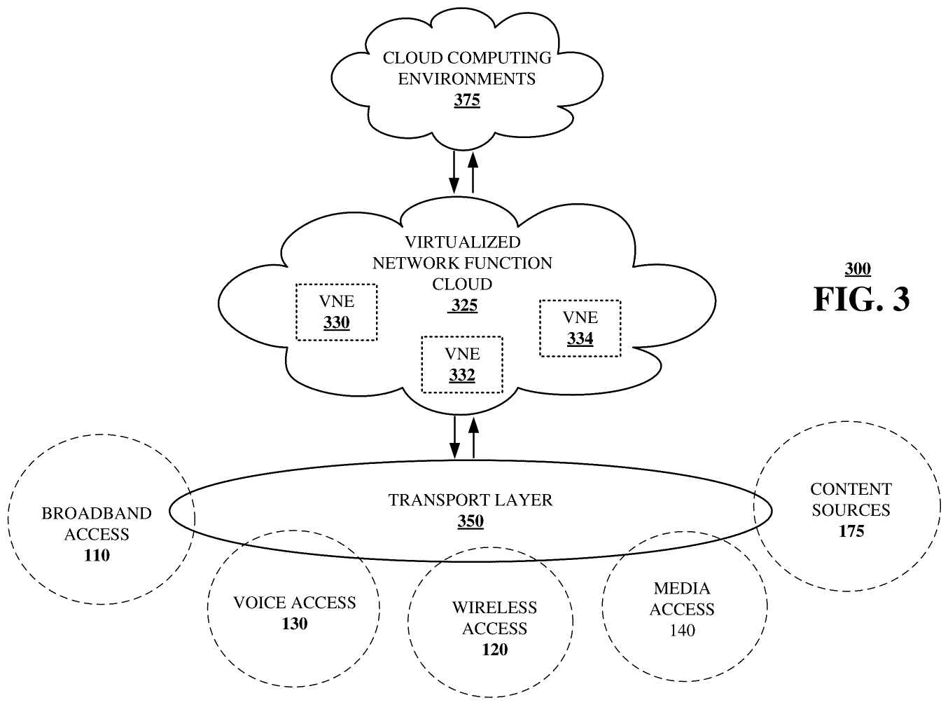

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of systems 1000, 1100, 1200 and/or some or all of the functions of methods 2000, 2100, 2200. For example, virtualized communication network 300 can facilitate in whole or in part a platform/framework that eliminates (or reduces) the need to repetitively re-create certain software interfaces.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element, such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

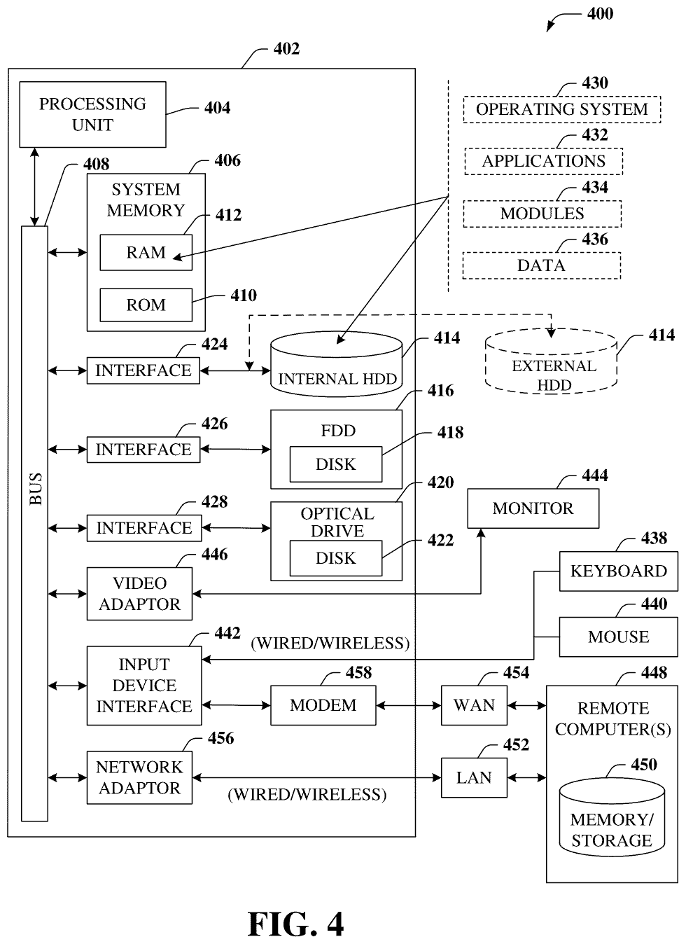

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements, access terminal, base station or access point, switching device, media terminal, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part a platform/framework that eliminates (or reduces) the need to repetitively re-create certain software interfaces.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically generating software interfaces) can employ various AI-based schemes for carrying out various embodiments thereof. Moreover, a classifier can be employed to determine a ranking or priority of each software program, software application, software service, software interface, template, and/or task. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the software program(s), software application(s), software service(s), software interface(s), template(s), and/or task(s) are to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
storing configuration information associated with a plurality of application programming interfaces (APIs), wherein the configuration information comprises first configuration information corresponding to a first API that facilitates communication with a first software service, and wherein the configuration information comprises second configuration information corresponding to a second API that facilitates communication with a second software service, wherein the second API is distinct from the first API, and wherein the second software service is distinct from the first software service;
receiving a first client request associated with a first software program, wherein the first client request identifies one of the first software service and the second software service as a selected software service; and
responsive to receiving the first client request, transmitting a first communication, wherein:
in a first case that the first client request identified the first software service as the selected software service, the first communication comprises first information that is sent to the first software service via the first API; and
in a second case that the first client request identified the second software service as the selected software service, the first communication comprises second information that is sent to the second software service via the second API.

2. The device of claim 1, wherein the first software program sends the first client request to the device during a run time operation of the first software program.

3. The device of claim 1, wherein:
in the first case that the first client request identified the first software service as the selected software service, the first information that is sent to the first software service comprises first data, first instructions to perform a first operation, or any first combination thereof; and
in the second case that the first client request identified the second software service as the selected software service, the second information that is sent to the second software service comprises second data, second instructions to perform a second operation, or any second combination thereof.

4. The device of claim 1, wherein:
in the first case that the first client request identified the first software service as the selected software service, a first responsive communication is received from the first software service by the device via the first API; and
in the second case that the first client request identified the second software service as the selected software service, a second responsive communication is received from the second software service by the device via the second API.

5. The device of claim 4, wherein:
in the first case that the first client request identified the first software service as the selected software service, the first responsive communication that is received from the first software service by the device comprises first data, first instructions to perform a first operation, or any first combination thereof; and
in the second case that the first client request identified the second software service as the selected software service, the second responsive communication that is received from the first software service by the device comprises second data, second instructions to perform a second operation, or any second combination thereof.

6. The device of claim 5, wherein:
in the first case that the first client request identified the first software service as the selected software service, the first data, the first instructions to perform the first operation, or the first combination thereof that is received from the first software service by the device is forwarded from the device to the first software program; and
in the second case that the first client request identified the second software service as the selected software service, the second data, the second instructions to perform the second operation, or the second combination thereof that is received from the second software service by the device is forwarded from the device to the first software program.

7. The device of claim 1, wherein each of the first software service and the second software service comprises a respective cloud application, a respective web application, a respective stand-alone application, a respective generative artificial intelligence (AI) application, a respective network application, or any respective combination thereof.

8. The device of claim 7, wherein each of the first software service and the second software service comprises a respective database operation, a respective database query, a respective database query result, a respective generative AI operation, a respective generative AI query, a respective generative AI query result, or any respective combination thereof.

9. The device of claim 7, wherein each network application comprises a wireless network application, a wired network application, or any combination thereof.

10. The device of claim 1, wherein the storing the configuration information comprises storing the configuration information in a database.

11. The device of claim 1, wherein the first software program comprises a cloud-based software program, a web-based software program, a stand-alone software program, or any combination thereof.

12. The device of claim 11, wherein the first software program facilitates a wireless network operation, a wired network operation, or any combination thereof.

13. The device of claim 1, wherein the operations further comprise:
receiving a second client request associated with a second software program, wherein the second client request identifies one of the first software service and the second software service as another selected software service; and
responsive to receiving the second client request, transmitting a second communication, wherein:
in a third case that the second client request identified the first software service as the another selected software service, the second communication comprises third information that is sent to the first software service via the first API; and
in a fourth case that the second client request identified the second software service as the another selected software service, the second communication comprises fourth information that is sent to the second software service via the second API.

14. The device of claim 13, wherein:
the first client request identified the first software service as the selected software service; and
the second client request identified the second software service as the another selected software service.

15. A non-transitory machine-readable medium comprising executable instructions that, when executed by a processing system including a processor, facilitate performance of operations, the operations comprising:
storing in a database a plurality of tasks, wherein the plurality of tasks comprise a first task and a second task, and wherein the first task is a different task than the second task;
storing in the database a plurality of application programming interface (API) calls, wherein the plurality of API calls comprise a first API call that is associated with the first task and a second API call that is associated with the second task, wherein the first API call is a different API call than the second API call, wherein the first API call facilitates communication with a first software service, wherein the second API call facilitates communication with a second software service, and wherein the first software service is a different software service than the second software service;
receiving a first client request associated with a first software program, wherein the first client request identifies the first task;
responsive to receiving the first client request, retrieving from the database the first API call that is associated with the first task;
responsive to receiving the first client request, transmitting a first communication to the first software service, wherein the first communication is made via the first API call that is retrieved;
responsive to the first communication being made, receiving a first responsive communication from the first software service, wherein the first responsive communication that is received comprises first data, first instructions to perform a first operation, or any first combination thereof; and
forwarding, to the first software program, the first data, the first instructions to perform the first operation, or the first combination thereof.

16. The non-transitory machine-readable medium of claim 15, wherein the operations further comprise:
receiving a second client request associated with the first software program, wherein the second client request identifies the second task;
responsive to receiving the second client request, retrieved from the database the second API call that is associated with the second task;
responsive to receiving the second client request, transmitting a second communication to the second software service, wherein the second communication is made via the second API call that is retrieved;
responsive to the second communication being made, receiving a second responsive communication from the first software service, wherein the second responsive communication that is received comprises second data, second instructions to perform a second operation, or any second combination thereof; and
forwarding, to the first software program, the second data, the second instructions to perform the second operation, or the second combination thereof.

17. The non-transitory machine-readable medium of claim 15, wherein the operations further comprise:
receiving a second client request associated with a second software program, wherein the second client request identifies the second task;
responsive to receiving the second client request, retrieved from the database the second API call that is associated with the second task;
responsive to receiving the second client request, transmitting a second communication to the second software service, wherein the second communication is made via the second API call that is retrieved;
responsive to the second communication being made, receiving a second responsive communication from the second software service, wherein the second responsive communication that is received comprises second data, second instructions to perform a second operation, or any second combination thereof; and
forwarding, to the second software program, the second data, the second instructions to perform the second operation, or the second combination thereof.

18. The non-transitory machine-readable medium of claim 17, wherein:
the first software program sends the first client request during a first run time operation of the first software program; and
the second software program sends the second client request during a second run time operation of the second software program.

19. A method comprising:
obtaining, by a processing system including a processor, a first application programming interface (API) call that facilitates communication with a first software service;
obtaining, by the processing system, a first task that can be requested for execution;
storing, by the processing system, the first task and the first API call in a database, wherein the first task and the first API call are associated with one another in the database;
obtaining, by the processing system, a second API call that facilitates communication with a second software service;
obtaining, by the processing system, a second task that can be requested for execution;
storing, by the processing system, the second task and the second API call in the database, wherein the second task and the second API call are associated with one another in the database;
receiving, by the processing system, a first request associated with a first software application, wherein the first request is for execution of the first task;
responsive to the receiving the first request, obtaining by the processing system, from the database, the first API call that is associated with the first task;
responsive to the obtaining the first API call from the database, transmitting by the processing system, a first communication to the first software service via the first API call;
receiving, by the processing system, a second request associated with a second software application, wherein the second request is for execution of the second task;
responsive to the receiving the second request, obtaining by the processing system, from the database, the second API call that is associated with the second task; and
responsive to the obtaining the second API call from the database, transmitting by the processing system, a second communication to the second software service via the second API call.

20. The method of claim 19, further comprising:
responsive to the first communication being transmitted, receiving by the processing system a first responsive communication from the first software service, wherein the first responsive communication that is received comprises first data, first instructions to perform a first operation, or any first combination thereof;
forwarding by the processing system, to the first software application, the first data, the first instructions to perform the first operation, or the first combination thereof;
responsive to the second communication being transmitted, receiving by the processing system a second responsive communication from the second software service, wherein the second responsive communication that is received comprises second data, second instructions to perform a second operation, or any second combination thereof; and
forwarding by the processing system, to the second software application, the second data, the second instructions to perform the second operation, or the second combination thereof.
